(19) United States
(12) Patent Application Publication
(10) Pub. No.: US 2003/0157231 A1
(43) Pub. Date: Aug. 21, 2003

(54) Shelf stable confectionery

(76) Inventor: Andre Kent Roberts, Wendouree (AU)

Correspondence Address: FITZPATRICK CELLA HARPER & SCINTO, 30 ROCKEFELLER PLAZA, NEW YORK, NY, 10112, US

(21) Appl. No.: 10/258,413

(22) PCT Filed: Apr. 19, 2001
(86) PCT No.: PCT/AU01/00452

(30) Foreign Application Priority Data
Apr. 20, 2000 (AU) 30088/00

(51) Int. Cl. A23L 1/00

(52) U.S. Cl. 426/564

(57) ABSTRACT

A confectionery product comprising low density chocolate surrounded by a sugar-based coating, and a process for producing the confectionery product. The confectionery product is shelf stable, even at elevated ambient temperatures.

### FIELD OF THE INVENTION

This invention relates to a novel confectionery and a process for preparing said novel confectionery. The confectionery comprises a chocolate core surrounded by a sugar-based coating.

### BACKGROUND OF THE INVENTION

Various confectionery products are known which incorporate chocolate within an outer sugar-based coating or shell. Such products include M&M's® (of Effem Foods) and SMARTIES® (of Nestle) and other similar confectionery products. These products have enjoyed wide consumer appeal and vast quantities of these products have been sold throughout the world. One problem of such confectionery products is that they are typically not shelf stable at elevated ambient temperatures, in that the internal chocolate melts and expands, causing the coating, or shell, to crack. The internal, molten, chocolate then oozes out through the cracks which disfigures the confectionery product. This significantly reduces the consumer appeal and, therefore, the value of the products. This poor shelf stability at elevated ambient temperatures has limited the commercial success of such products in countries having warmer climates and/or where refrigeration is not widespread. This lack of shelf stability at elevated ambient temperatures can limit the market appeal of such confectionery products as, in hot weather or when exposed to direct sunlight, there is a tendency for the coating to crack and the inner chocolate to ooze out.

A variety of means have been attempted to produce a commercially acceptable confectionery, having a chocolate centre and a sugar shell, for hotter regions of the world. Some of the methods involve altering the ingredients of the chocolate centre, others involve treatment of the shell and others, treatment of both the chocolate centre and the sugar shell.

For instance, attempts have been made to make the chocolate centre more robust by adding water to the centre, which establishes a sugar rather than fat matrix as the backbone of the chocolate structure. Such attempts have resulted in a chocolate centre that melts at much higher temperatures. However, turning this concept into a commercial reality has proven to be difficult due to the rheological change of the chocolate that takes place (One such change is the dramatic increase in the yield stress of the water added chocolate). Higher melting point fats have also been added to the chocolate formulation in the past in an attempt to increase the melting point of the chocolate centre. However, this can result in chocolate having an undesirable taste or texture.

Over the last five decades, numerous patents have been granted for inventions directed to making chocolate stable at temperatures above the typical melting points of the fats in milk chocolate. Many of the patents seek heat stability by adding water to chocolate, causing amorphous sugars to crystallise, or using noncrystallising amorphous sugars.

U.S. Pat. No. 5,149,560 involves creating a stable water-in-oil emulsion, for example, a hydrated lecithin, and then adding the emulsion to tempered chocolate to form a heat-stable chocolate.

U.S. Pat. No. 5,004,623 involves mixing a foam into the tempered paste, and stabilising the foam with either emulsifiers or with a protein to form a heat stable chocolate.

Swiss Patent No. 662041 concerns spraying water directly into mixing chocolate. The chocolate necessarily contains milk powder. The chocolate is said to be heat-stable.

Japanese Patent No. 60-27339 involves imparting heat resistance to chocolate by adding a water-in-oil emulsion just prior to enrobing or moulding.

U.S. Pat. No. 4,446,166 involves creating heat-resistant chocolate by mixing into chocolate a water-in-fat emulsion.

U.S. Pat. No. 2,480,935 concerns adding water to chocolate directly, just prior to moulding or enrobing. An emulsifier is recommended to assist in the addition of water to the chocolate. It is considered that heat resistance requires a maximum of 35% fat.

U.S. Pat. No. 2,863,772 discloses coating sucrose and milk protein with invertase and some water. Heat resistance is obtained after final shaping.

U.S. Pat. No. 2,480,935 and U.S. Pat. No. 2,760,867 relates to imparting heat stability to chocolate by enveloping the confection in a sugar-crystal mat. This sugar-crystal mat is induced from sugar bloom and is created by dissolving sugar crystals on the surface of the confection. The sugar syrup is then dried, producing a surface mat of intertwined crystals encasing the confection. By doing so, the confection does not “oil off” when held at temperatures above the melting point of fat.

U.S. Pat. No. 2,487,931 involves dissolving sugars at elevated temperatures and crystallisation of the sugars when the chocolate mass is cooled to room temperature. The resultant confectionery does not deform at any temperature below the charring point of sugar.

Treatments of the sugar shell have involved varying shell configurations and formulations aimed at making the shell more pliable and resistant to increased internal pressure.

### OBJECTS OF THE INVENTION

It is an object of the invention to provide a confectionery product having a chocolate centre and sugar-based coating, which has improved shelf stability even at elevated ambient temperatures compared to existing such confectionery products.

It is a further object of the invention to provide a method for manufacturing such a shelf stable confectionery product having a chocolate centre and a sugar-based coating.

### SUMMARY OF THE INVENTION

The present invention is based on the discovery that a confectionery product which is stable even at elevated ambient temperatures can be made by using a low density chocolate as the chocolate core of the confectionery product within a sugar-based outer coating, without having to modify the chemical composition of the chocolate core or the coating. The low density chocolate is a chocolate comprising voids within the chocolate. The invention involves the recognition that, during a phase change from the solid polymorphic state to the liquid chocolate state, and when the chocolate is located within an outer coating (or shell), the expansion in volume of the chocolate compresses pockets of gaseous fluid within the confectionery product core rather than expanding beyond the volume defined by the coating.

According to a first embodiment of the invention there is provided a confectionery product comprising low density chocolate surrounded by a sugar-based coating.

According to a second embodiment of the invention there is provided a confectionery product comprising a chocolate core and a sugar coating, characterised in that the chocolate core comprises voids.

According to third embodiment of the invention there is provided a process for preparing a confectionery product comprising:

a) reducing the density of a chocolate mix to form a low density chocolate;

b) moulding said low density chocolate into a desired shape;

c) coating said moulded low density chocolate with a sugar-based coating.

According to a fourth embodiment of the invention there is provided a process of preparing a confectionery product comprising a chocolate core and a sugar-based coating, characterised in that the process comprises the steps of:

a) incorporating voids into a chocolate mix to form a low density chocolate;

b) moulding said low density chocolate into a desired shape;

c) coating said moulded low density chocolate with a sugar-based coating to form said confectionery product.

It is preferred that the density of the low density chocolate be in the range of from about 0.6 to about 1.25 g/ml. A density of about 1.20 g/ml is particularly desirable. This is lower than the density of the chocolate core of similar types of prior confectionery products, such as SMARTIES® and earlier types of M&M's®, discussed above, which typically had a density of about 1.29-1.31 g/ml.

Definitions

When used in this specification, the following terms have the meanings given below:

The term “shelf-stable” means that the confectionery is stable even at elevated ambient temperatures. That is, the sugar based coating does not show, or shows limited, disfiguring changes, such as cracking or oozing of the chocolate centre out of the confectionery coating.

The term “comprises/comprising” is taken to specify the presence of stated features, integers, steps or components but does not preclude the presence or addition of one or more other features, integers, steps, components or groups thereof.

The term “chocolate” as used herein is intended to mean not only conventional chocolates, that is those which contain cocoa, a fat such as cocoa butter, sugar and optionally milk and flavourings, but also the so-called “white” chocolates which do not contain cocoa. The term is also intended to include products containing cocoa and a fat other than cocoa butter. For example, the chocolate may be “white” chocolate, “dark” chocolate, “milk” chocolate, compound mixture and/or mixtures thereof.

The term “chocolate mix” as used herein refers to the mixture of ingredients which make up the chocolate before further treatment, for example, tempering.

### BRIEF DESCRIPTION OF THE DRAWINGS

FIG. 1 is a schematic diagram showing a preferred embodiment of the process according to the invention.

### DETAILED DESCRIPTION OF THE INVENTION

The chocolate mix used in the present invention generally comprises standard chocolate-making ingredients known in the art. Typically, the chocolate mix would be made up of cocoa fat in the range of about 20-50% by weight, milk and sugar powders, liquid fats and flavours.

The low density chocolate may be formed by incorporation of gas pockets into the chocolate mix. The gas may be selected from air, N₂ or CO₂, although for the purposes of the present invention, air has been found to be the most appropriate. Typically, the air is provided in the form of compressed air.

The chocolate mix is usually tempered before incorporation of the gas pockets therein. The tempering of the chocolate can be achieved by traditional means, typically, by heating the chocolate mix to about 45° C., cooling to about 27° C. and then reheating to about 30° C.-32° C. For example, the chocolate mix (which typically has a temperature of about 45° C. after mixing of the basic ingredients) can then be passed through a heat exchanger, such as a scraped surface heat exchanger, having a low temperature region, and, can be then reheated in a temper kettle to the desired polymorphic state. Chocolate tempered to a desired level typically has a majority of the β form of crystals. It is preferable that the temper values have a slope in the range of about −2.0 to about 0.01 (at the point of inflection), and a chocolate temper unit value in the range of about 6.7 to about 10.0.

The chocolate mix, which may be tempered, and the gas which is to be incorporated into the chocolate mix, is led to a mixing chamber via pipes. The pipes are usually jacketed at a predetermined temperature. In addition, the mixing chamber itself is usually jacketed at a given temperature. Preferred jacketing is by means of water or glycol/water, in particular food-grade glycol, so that if there were leakage of the jacketing fluid into the production line, the batch may not have to be destroyed. The chocolate mix is cooled usually to about 25° C.-33° C. before entering the mixing chamber. This cooling may be achieved by means of a scraped surface heat exchanger.

The gas is typically incorporated into the chocolate mix by pumping of the gas and chocolate mix into the mixing chamber together with rapid mixing of the chocolate mix and gas. It is preferred to add the gas at a rate of about under, or half, the rate at which the chocolate mix is added to the mixing chamber. If the mixing action is not sufficiently rapid, the gas will leave the resulting chocolate/gas mixture when it is exposed to the ambient environment. A preferred type of mixer is a rotor-stator type of mixing head, although other mixers known in the art such as a planetary whipper or b-votator would also adequately incorporate the gas into the chocolate.

When a rotor-stator mixing head is used, the rotor preferably moves at a approximately 40-300 revolutions per minute. During mixing, the chocolate/gas mixture usually heats up and a cooling jacket is required to ensure that the outlet temperature of the chocolate/gas mixture is approximately equal to the inlet temperature. The mixing chamber is cooled such that the chocolate, with gas pockets incorporated therein, leaving the mixing chamber is no more than about 31° C., with temper values in the same range as the inlet temper values. The outlet temperature of the chocolate, which has gas pockets incorporated therein, is usually about the same as the inlet temperature of the chocolate mix.

The chocolate, which has small pockets of gas incorporated therein, is referred to herein as “low density chocolate”, and has a density preferably in the range of about 0.6 to about 1.25 g/ml. Typically, chocolate which is not reduced in density has a density in the range of about 1.29-1.31 g/ml.

The low density chocolate is then moulded to the desired shape and size. A preferred shape is bi-convex, lens-shaped. A preferred size is “bite-size”, that is, a piece (or several pieces) which may be put whole into a consumer's mouth. Clearly, however, any desired shape or size would fall within the scope of the invention.

Moulding may be by any process known in the art used to mould confectioneries. In a preferred method, a slab of the low density chocolate is deposited onto chilled moulding rolls. The deposited slab is preferably of approximately constant thickness. The moulding rolls are at a temperature low enough to ensure that the final moulded shapes, after sifting (to remove flashing) and rolling (to smooth edges) are hard enough to withstand the sugar-coating process. Typically, the sifting and rolling occur simultaneously in a rotating sieve, although these procedures could be carried out separately.

The moulded shapes are then coated with a sugar-based coating by conventional means. The sugar-based coating may comprise one or more sugar-based layers. Preferably, more than one sugar-based layer is applied using a lamination process. Most preferably, at least one layer comprising sugar and water is applied, followed by layers comprising sugar, water and colours. It is usual in such a process to allow each layer to dry before adding the next layer. This layering process is repeated as many times as is required, depending on the final desired shell thickness. The final shell thickness is typically about 10-50% by weight of the confectionery and is desirably of even thickness throughout. It is usual to polish the finished confectionery before packaging. Printing may be added to the polished surface, and different coloured confectionery pieces blended together.

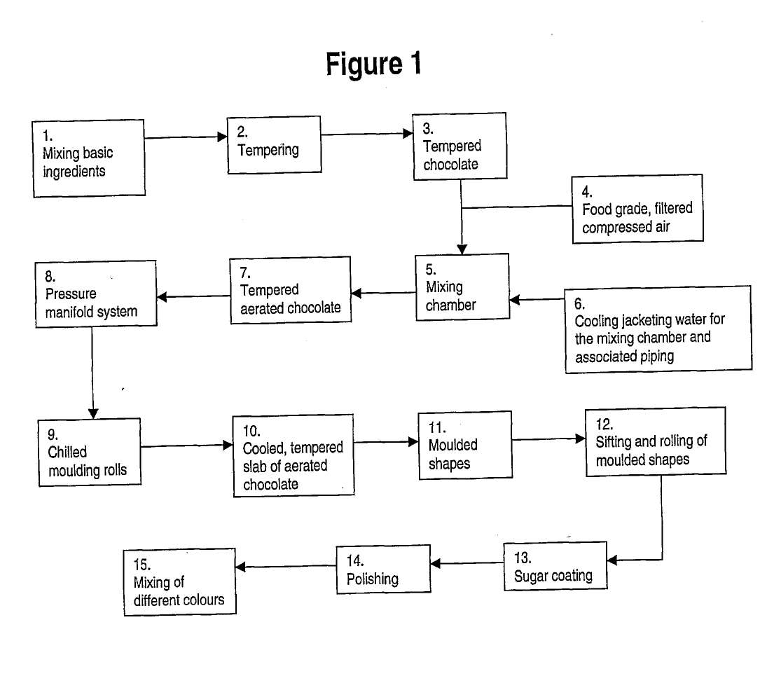

FIG. 1 shows a schematic diagram of a preferred embodiment of the process of this invention. The basic chocolate ingredients are mixed to form a chocolate mix (1), followed by tempering (2) of the chocolate mix. The tempered chocolate (3) and food grade, filtered, compressed air (4) are fed into a mixing chamber (5). The compressed air is delivered at a pressure higher than that in the mixing chamber. The pipework to the mixing chamber and the mixing chamber itself is cooled (6) with jacketing water to ensure that the outlet temperature of the aerated chocolate leaving the mixing chamber is equal to, or slightly above, the inlet temperature of the chocolate mix/air. In this preferred embodiment the mixing chamber comprises a rotor-stator mixing head which mixes the compressed air into the tempered chocolate by a whipping-type of action. This whipping action incorporates small pockets of air into the tempered chocolate to form aerated, tempered chocolate (7). The aerated, tempered chocolate is then pumped into an adjustable high-pressure manifold (8), from which it is deposited onto chilled moulding rolls (9). The chilled moulding rolls have a heated wedge in the rolls to overcome the increased yield stress of the aerated, tempered chocolate. A cooled slab of the aerated, tempered chocolate is formed (10), which is then moulded into shapes (11). The moulded shapes are then sifted and rolled (12), followed by coating with several coats of sugar-based coating (13), thereby forming the confectionery according to the invention. The pieces of confectionery may then be polished (14). Different colours of the confectionery pieces can then be mixed together (15).

In an even more preferred embodiment to the process described in FIG. 1 above, the tempered chocolate mix is cooled to about 27-28° C. before being fed into mixing chamber (5). By cooling the tempered chocolate mix, the mixing head speed can be increased, which results in more, smaller pockets of air.

The finished confectionery is shelf stable, even up to about 50° C. In typical warmer climates, for example at about 35° C., the degree of cracking, disfigurement, oozing out of the chocolate centre and/or fat bleed is limited, and might not occur at all. Even if the finished product is dropped and the shell cracks as a result of this, limited, if any, oozing form the chocolate centre occurs. Furthermore, even at temperatures up to about 50° C., the majority of the confectionery products show no cracking, disfigurement, oozing or fat bleed. The confectionery has the desired taste, texture and mouthfeel.

The invention will now be described with reference to the following example, which is not intended to limit the scope of the invention.

### EXAMPLE

Manufacture of Chocolate

Firstly, mixtures of milk and sugar powders are refined. Powdered flavours are then added to this mixture. The powders are then added to controlled amounts of liquid fats with a pin mixer. Typically, a fat content of between 20%-50% is used, with a hard to soft fat ratio between 2-5. After the refining of powders and the mixing of the powders and liquids, the majority of particle sizes occur between about 20-75 microns.

The chocolate mix is then tempered as follows: after the chocolate mix has been heated to above 45° C., it is cooled to about 27° C. and then re-heated to about 30° C.-32° C. An ideal set of temper values is with a slope in the range of −2.0 to about 0.01 (at the point of inflection) and a chocolate temper unit value in the range of about 6.7 to about 10.0. The tempered chocolate is then passed through a scraped surface heat exchanger, reducing the temperature to about 25° C. to about 33° C.

The final viscosity of the tempered chocolate, before it enters the mixing chamber is generally between 6-12 Pa.s.

An air stream is added to the chocolate mix stream at an ideal rate of under, or around half, that of the rate of addition of the chocolate mix. The combined air and chocolate mix are then mixed vigorously with a rotor-stator, the rotor moving at between about 40-300 revolutions per minute. The pressure in the mixing chamber should be less than the pressure of the chocolate line to the mixing chamber and less than the pressure of the air stream to the mixing chamber.

The rotor-stator is cooled with 15° C.-25° C. jacketing water such that the temperature of the aerated chocolate leaving the mixing chamber is no more than about 33° C., with temper values in the same range as those stated for the inlet chocolate mix.

Following the mixing chamber, the aerated chocolate passes through jacketed pipework (jacketed at about 33° C.) to a manifold, that can be manually altered to change the back-pressure to the mixing head.

From the manifold, the chocolate is deposited onto chilled moulding rolls and formed into a web of bi-convex, lens-shaped cores. The rolls are cooled with either water or a glycol-water mix, ideally in the range of −22° C.-−11° C., ideally about −6° C. such that the ideal temperature of the chocolate leaving the rolls is between 5-16° C.

The aerated moulded chocolate is then cooled in a cooling tunnel. The cooling tunnel ideally has a residence time of 8-15 minutes and a dry bulb temperature of less than about 7° C.

The moulded chocolate then enters a rotating sieve, which removes the flash from the bi-convex, lens-shaped chocolate cores.

Coating the Product

The smooth, correctly shaped product is then coated with a layer comprising sugar and water. The coating is done using any process equipment that can achieve a desired, even thickness of shell with an appropriate finished water activity (ideally around 0.25) in a commercially feasible time.

After this layer has dried, further layers comprising sugar and water may be applied, and dried, followed by layers comprising sugar, water and colours. After each layer has dried, further syrup is added, which completely covers the coated pieces, and then is dried. The desired finished shell percentage to chocolate percentage is achieved by repeating this step as many times as is required.

The shell percentage will generally fall between 10%-50% by weight.

The finished product is then polished and different coloured finished pieces are blended together. Pieces may then have printed symbols added to their polished surface, before the product is packed out.

The finished product typically has a chocolate centre with a density between about 0.60-1.25 g/ml, preferably about 1.20 kg/litre. The sugar shell completely covers the finished piece.

The finished bite size confection exhibits shelf stability even at elevated ambient temperatures, compared to non-aerated product. Tests show the product to be shelf stable from 16° C.-50° C.

The claims defining the invention are as follows:

1. A shelf-stable confectionery product comprising low density, tempered chocolate surrounded by a sugar-based coating.

2. A shelf-stable confectionery product according to claim 1, wherein the density of the low density, tempered chocolate is in the range of about 0.6 to about 1.25 g/ml.

3. A shelf-stable confectionery product according to claim 2, wherein the density is about 1.20 g/ml.

4. A shelf-stable confectionery product according to any one of claims 1 to 3, wherein said low-density, tempered chocolate has gas incorporated therein.

5. A shelf-stable confectionery product according to claim 4, wherein said gas is air.

6. A shelf-stable confectionery product according to any one of claims 1 to 5, wherein the low density, tempered chocolate comprises about 20-50% by weight cocoa fat, milk powder, sugar powder, liquid fat and flavour.

7. A shelf-stable confectionery product according to any one of claims 1 to 6, wherein the sugar-based coating comprises at least one layer comprising sugar and water, coated with at least one layer comprising sugar, water and colour.

8. A shelf stable confectionery product comprising a chocolate core and a sugar-based coating, characterised in that the chocolate core is tempered chocolate comprising voids, in the form of a gas.

9. A shelf-stable confectionery product according to claim 8, characterised in that the gas is air.

10. A shelf-stable confectionery product according to claim 8 or claim 9, wherein the density of the low density, tempered chocolate is in the range of about 0.6 to about 1.25 g/ml.

11. A shelf-stable confectionery product according to claim 10, wherein the density is about 1.20 g/ml.

12. A shelf-stable confectionery product according to any one of claims 8 to 11, characterised in that the chocolate core comprises about 20-50% by weight cocoa fat, milk powder, sugar powder, liquid fat and flavour.

13. A shelf-stable confectionery product according to any one of claims 8 to 12, characterised in that the sugar-based coating comprises at least one layer comprising sugar and water, coated with at least one layer comprising sugar, water and colour.

14. A shelf-stable confectionery product according to any one of claims 1 to 13, which is bite-sized.

15. A shelf-stable confectionery product substantially as herein described with reference to the Example.

16. A process for preparing a shelf-stable confectionery product, comprising:
a) tempering a chocolate mix to form tempered chocolate
b) reducing the density of the tempered chocolate, by incorporating gas into said tempered chocolate to form a low density, tempered chocolate;
c) moulding said low density, tempered chocolate into a desired shape by extruding the low density, tempered chocolate onto one or more chilled moulding rolls;
d) coating said moulded, low density, tempered chocolate with a sugar-based coating to form said shelf-stable confectionery product.

17. A process of preparing a shelf-stable confectionery product comprising a chocolate core and a sugar-based coating, characterised in that the process comprises the steps of:
a) tempering a chocolate mix to form tempered chocolate
b) incorporating voids in the form of gas into said tempered chocolate mix to form a low density, tempered chocolate;
c) moulding said low density, tempered chocolate into a desired shape by extruding said low density, tempered chocolate onto chilled moulding rolls;
d) coating said moulded, low density, tempered chocolate with a sugar-based coating to form said shelf-stable confectionery product.

18. A process according to claim 16 or claim 17, wherein said gas is incorporated into said chocolate mix by rapid mixing of said chocolate mix together with said gas.

19. A process according to claim 18, wherein said rapid mixing is carried out by means of a rotor moving at between 40-300 revolutions per minute.

20. A process according to any one of claims 15 to 18 wherein the tempering step includes the steps of (I) heating the chocolate mix to above 45° C., then (ii) cooling the chocolate mix to about 27° C. and then (iii) reheating the chocolate mix to about 30° C. to about 32° C., thereby forming said tempered chocolate.

21. A process according to claim 20, further comprising cooling the tempered chocolate to about 25° C.-33° C. before step (b).

22. A process according to any one of claims 16 to 21, wherein the density of said low density, tempered chocolate is in the range of about 0.6 to about 1.25 g/ml.

23. A process according to claim 22 wherein the density is about 1.20 g/ml.

24. A process according to any one of claims 16 to 23, wherein the low density, tempered chocolate is formed into a slab of approximate constant thickness before said moulding step.

25. A process for preparing a confectionery product, which process is substantially as herein described with reference to the Example.

26. A process for preparing a confectionery product, which process is substantially as herein described with reference to FIG. 1.

27. A confectionery product prepared by a process of any one of claims 16 to 26.
